(19) United States
(12) Patent Application Publication
(10) Pub. No.: US 2019/0373892 A1
(43) Pub. Date: Dec. 12, 2019

(54) FORMALDEHYDE-FREE PRESERVATIVES FOR HIGHLY SUSCEPTIBLE PRODUCTS

(71) Applicant: Troy Corporation, Florham Park, NJ (US)

(72) Inventors: Richard S. VALPEY, III, Rockaway, NJ (US); Jake Zachary JACOBS, Florham Park, NJ (US)

(73) Assignee: Troy Corporation, Florham Park, NJ (US)

(21) Appl. No.: 16/434,959

(22) Filed: Jun. 7, 2019

Related U.S. Application Data
(60) Provisional application No. 62/682,958, filed on Jun. 10, 2018.

(51) Int. Cl. A01N 43/80; A01N 47/14; C04B 41/46

(52) U.S. Cl. CPC A01N 43/80; C04B 2103/69; C04B 41/46; A01N 47/14

(57) ABSTRACT

Formaldehyde-free preservative blends of 1,2-benzisothiazol-3(2H)-one (“BIT”) and certain dithiocarbamates inhibit microbial degradation of products that include ingredients which are naturally susceptible to, or have been previously exposed to, microbial contamination. This combination is effective in materials such as mineral slurries, pulp and paper slurries, wallboard joint compounds, mastics and asphalt emulsions. Also, methods for inhibiting the growth of microbes during storage of these materials without the use of formaldehyde or formaldehyde-releasing products.

### CROSS-REFERENCE TO RELATED APPLICATIONS

This application claims priority from U.S. Application No. 62/682,958 filed on Jun. 10, 2018, the entire disclosure of which is incorporated herein by reference in its entirety for all purposes.

### FIELD OF THE INVENTION

The present invention relates to antimicrobial compositions of matter and methods for inhibiting the growth of bacteria, fungi, and other microbes.

### BACKGROUND OF THE INVENTION

Regulatory pressures on preservatives that contain formaldehyde have restricted their use in aqueous products. For resinous products composed of synthetic materials, formaldehyde-free preservatives are commercially are available that, together with improvements in manufacturing plant hygiene and adoption of higher quality synthetic materials, provide adequate protection against bacterial and fungal degradation. In contrast, relatively few formaldehyde free preservatives provide adequate protection for products composed of ingredients that are highly susceptible to or previously contaminated by bacteria and fungi.

The susceptible products, i.e. materials to be protected by the addition of a preservative include paints, coatings, mineral slurries, pigment dispersions, pulp and paper slurries, lattices (including but not limited to polymer lattices based on acrylate, butadiene, PVA, EVA, styrene, and vinyl acetate), wallboard joint compounds, wallboard, spackling, sealants, stucco, mastics, and asphalt emulsions. Avoiding exposure of these materials to microbial contamination throughout the manufacturing process through hygiene improvements and raw material monitoring remains important, but in many cases microbial exposure is inevitable. Consequently, many manufacturers of the susceptible products are presently relying on formaldehyde and formaldehyde-releasing products (“FRP”) to reduce spoilage. The wallboard industry in particular would welcome new preservatives that exhibit strong, long-lasting activity against fungus and bacteria. Ideally, the new preservatives are low in toxicity and environmental impact.

Wallboard joint compound (also known as drywall joint compound or wallboard mud) is used to attach tape to wallboard (also known as drywall, plasterboard or sheetrock) in order to cover the tape and conceal imperfections in the surface of the wallboard. A typical wallboard joint compound contains substantial proportions of gypsum or limestone and water with relatively small proportions of stone, clay, and a polymer.

Because some of these typical ingredients in a product or material to be protected are of natural origin and may have been previously exposed to fungal or bacterial contamination, conventional wallboard joint compounds or other products or materials to be protected are generally susceptible to “in-can” microbial degradation during storage. In order to inhibit this degradation, many conventional wallboard joint compounds include formaldehyde or formaldehyde-releasing preservatives (“FRPs”), such as quatemium-15, DMDM hydantoin, imidazolidinyl urea, diazolidinyl urea, polyoxymethylene urea, sodium hydroxymethylglycinate, bronopol, and glyoxal.

As some formulators move away from these highly effective formaldehyde-based preservatives, a need exists for a formaldehyde-free preservative that can provide adequate preservative protection for the susceptible products, such as mineral slurries, pulp and paper slurries, wallboard joint compounds, mastics, and asphalt emulsions.

### SUMMARY OF THE INVENTION

It has now been discovered that formaldehyde-free preservative blends of 1,2- 1,2-benzisothiazol-3(2H)-one, also referred to herein as 1,2-benzothiazol-3-one (“BIT”) and certain dithiocarbamates are effective for inhibiting microbial degradation of products which include highly susceptible ingredients or have been previously exposed to bacterial contamination. This combination is particularly effective when incorporated in materials such as mineral slurries, pulp and paper slurries, wallboard joint compounds, mastics and asphalt emulsions.

In a preferred aspect, the invention is a preservative composition, which comprises 1,2-benzisothiazol-3(2H)-one, also referred to herein as 1,2-benzothiazol-3-one (“BIT”), and a metal salt of a carbamodithioic acid. The metal salt of a carbamodithioic acid is selected from the group consisting of: sodium N-methylcarbamodithioate (“Metam Sodium”); potassium N-methylcarbamodithioate (“Metam Potassium”); zinc N,N-dimethylcarbamodithioate (“Ziram”); sodium N,N-dimethylcarbamodithioate (“Dibam”); potassium N,N-dimethylcarbamodithioate (“Dibam Potassium”); dimethylcarbamothioylsulfanyl N,N-dimethylcarbamodithioate (“Thiram”); zinc N-[2-(sulfidocarbothioylamino)ethyl]carbamodithioate (“Zineb”); disodium N-[2-(sulfidocarbothioylamino)ethyl]carbamodithioate (“Nabam”); zinc, manganese(2+)N-[2-(sulfidocarbothioylamino)ethyl]carbamodithioate (“Mancozeb”); manganese(2+)N-[2-(sulfidocarbothioylamino)ethyl]carbamodithioate (“Maneb”); zinc N-[1-(sulfidocarbothioylamino)propan-2-yl]carbamodithioate (“Propineb”); tetrahydro-3,5-dimethyl-2H-1,3,5-thiadiazin-2-thion (“Dazomet”); and mixtures thereof.

The metal salt of a carbamodithioic acid may be selected from the group consisting of Dibam, Dibam Potassium, Ziram, Thiram, Mancozeb, or a mixture thereof. The preservative composition may include essentially no formaldehyde or formaldehyde-releasing products and is suitable for use in a wallboard joint compound, a pulp and paper slurry, a mineral slurry, an asphalt emulsion, a mastic or a mixture of thereof. The preservative composition comprising BIT and the metal salt of a carbamodithioic acid synergistically inhibits the growth of bacteria and fungi.

In another aspect, the invention is a method for inhibiting the growth of bacteria and fungi during storage in a material (i.e. protecting the material during storage), wherein the material to be protected is selected from the group consisting of a wallboard joint compound, a pulp and paper slurry, a mineral slurry, a wallboard joint compound, an asphalt emulsion, or a mastic. The method comprises introducing BIT and a metal salt of a carbamodithioic acid into a material to be protected selected from the group consisting of a wallboard joint compound, a pulp and paper slurry, a mineral slurry, a wallboard joint compound, an asphalt emulsion, or a mastic to produce a protected material, and thoroughly mixing the protected material.

### BRIEF DESCRIPTION OF THE DRAWINGS

FIG. 1 is a chart that portrays Minimum Inhibitory Concentration (“MIC”) exhibited by Ziram, BIT, and five different blends of Ziram and BIT against a strain of bacteria known as Pseudomonas aeruginosa in nutrient broth;

FIG. 2 is a chart that depicts the mean value of Synergy Index observed for a series of experiments in which each of five different blends of Ziram and BIT synergistically inhibited the growth of Pseudomonas aeruginosa bacteria in a wallboard joint compound; and

FIG. 3 is a chart showing the synergy index for four different dithiocarbamates and at five different dithiocarbamate:BIT ratios for each compound tested.

### DETAILED DESCRIPTION OF THE INVENTION

The invention is a formaldehyde-free preservative for materials or products composed of ingredients that are highly susceptible to, or have previously been exposed to, contamination by bacteria and/or fungi. Examples of these highly susceptible products or materials include mineral slurries, pulp and paper slurries, wallboard joint compounds, mastics and asphalt emulsions.

In an embodiment, the formaldehyde-free preservative includes 1,2 benzisothiazol-3(2H)-one (“BIT”) and one or more carbamodithioic acid metal salts selected from the group consisting of: sodium N-methylcarbamodithioate (“Metam Sodium”); potassium N-methylcarbamodithioate (“Metam Potassium”); zinc N,N-dimethylcarbamodithioate (“Ziram”); sodium N,N-dimethylcarbamodithioate (“Dibam”); potassium N,N-dimethylcarbamodithioate (“Dibam Potassium”); dimethylcarbamothioylsulfanyl N,N-dimethylcarbamodithioate (“Thiram”); zinc N-[2-(sulfidocarbothioylamino)ethyl]carbamodithioate (“Zineb”); disodium N-[2-(sulfidocarbothioylamino)ethyl]carbamodithioate (“Nabam”); zinc, manganese(2+)N-[2-(sulfidocarbothioylamino)ethyl]carbamodithioate (“Mancozeb”); manganese(2+)N-[2-(sulfidocarbothioylamino)ethyl]carbamodithioate (“Maneb”); zinc N-[1-(sulfidocarbothioylamino)propan-2-yl]carbamodithioate (“Propineb”); tetrahydro-3,5-dimethyl-2H-1,3,5-thiadiazin-2-thion (“Dazomet”); and mixtures thereof.

The formaldehyde-free preservative excludes formaldehyde and excludes formaldehyde-releasing preservatives (“FRPs”).

In an embodiment, the invention is a preservative composition for inhibiting in-can bacterial and fungal degradation of a product or material to be protected, e.g. wallboard joint compound. The preservative composition comprises BIT and one or more carbamodithioic acid metal salts as listed above, such as zinc N,N-dimethylcarbamodithioate (“Ziram”) as biologically active ingredients. The total mass of BIT and one or more carbamodithioic acid metal salts as listed above, such as Ziram, in the preservative composition constitutes about 1% to about 90% by mass of the preservative composition or up to 100% of the preservative composition, alternatively about 2% to about 30%. The mass ratio of BIT to one or more carbamodithioic acid metal salts as listed above, such as Ziram, in the preservative composition is in the range of about 0.01:1 to about 100:1, alternatively is in the range of about 0.1:1 to about 10:1, or alternatively is in the range of about 0.3:1 to about 3:1. For example the mass ratio of BIT to one or more carbamodithioic acid metal salts as listed above, such as Ziram, in the preservative composition may be 0.01:1, 0.05:1, 0.1:1, 0.15:1, 0.2:1, 0.25:1, 0.3:1, 0.35:1, 0.4:1, 0.45:1, 0.5:1, 0.55:1, 0.6:1, 0.65:1, 0.7:1, 0.75:1, 0.8:1, 0.85:1, 0.9:1, 0.95:1, 1:1, 1.1:1, 1.2:1, 1.3:1, 1.4:1, 1.5:1, 1.6:1, 1.7:1, 1.8:1, 1.9:1, 2:1, 2.5:1, 2.6:1, 2.7:1, 2.8:1, 2.9:1, 3:1, 4:1, 5:1, 6:1, 7:1, 8:1, 9:1, 10:1, 12.5:1, 15:1, 20:1, 25:1, 30:1, 35:1, 40:1, 45:1; 50:1, 55:1, 60:1, 65:1, 70:1, 75:1, 80:1, 85:1, 90:1, 95:1.

The total amount of the BIT and a metal salt of a carbamodithioic acid as disclosed herein added to a product or material to be protected from microbial growth may comprise from 10 parts per million weight (ppm) to 10000 ppm of the protected product or material. For example the total amount of the BIT and a metal salt of a carbamodithioic acid composition disclosed herein that is added to a product or material to be protected from microbial growth may comprise 10 parts per million weight (ppm), 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 95 ppm, 100 ppm, 150 ppm, 200 ppm, 250 ppm, 300 ppm, 350 ppm, 400 ppm, 450 ppm, 500 ppm, 550 ppm, 600 ppm, 650 ppm, 700 ppm, 750 ppm, 800 ppm, 850 ppm, 900 ppm, 950 ppm, 1000 ppm, 1050 ppm, 1100 ppm, 1150 ppm, 1200 ppm, 1250 ppm, 1300 ppm, 1350 ppm, 1400 ppm, 1450 ppm, 1500 ppm, 1550 ppm, 1600 ppm, 1650 ppm, 1700 ppm, 1750 ppm, 1800 ppm, 1850 ppm, 1900 ppm, 1950 ppm, 2000 ppm, 2050 ppm, 2100 ppm, 2150 ppm, 2200 ppm, 2250 ppm, 2300 ppm, 2350 ppm, 2400 ppm, 2450 ppm, 2500 ppm, 2550 ppm, 2600 ppm, 2650 ppm, 2700 ppm, 2750 ppm, 2800 ppm, 2850 ppm, 2900 ppm, 2950 ppm, 3000 ppm, 3050 ppm, 3100 ppm, 3150 ppm, 3200 ppm, 3250 ppm, 3300 ppm, 3350 ppm, 3400 ppm, 3450 ppm, 3500 ppm, 3550 ppm, 3600 ppm, 3650 ppm, 3700 ppm, 3750 ppm, 3800 ppm, 3850 ppm, 3900 ppm, 3950 ppm, 4000 ppm, 4050 ppm, 4100 ppm, 4150 ppm, 4200 ppm, 4250 ppm, 4300 ppm, 4350 ppm, 4400 ppm, 4450 ppm, 4500 ppm, 4550 ppm, 4600 ppm, 4650 ppm, 4700 ppm, 4750 ppm, 4800 ppm, 4850 ppm, 4900 ppm, 4950 ppm, 5000 ppm, 5050 ppm, 5100 ppm, 5150 ppm, 5200 ppm, 5250 ppm, 5300 ppm, 5350 ppm, 5400 ppm, 5450 ppm, 5500 ppm, 5550 ppm, 5600 ppm, 5650 ppm, 5700 ppm, 5750 ppm, 5800 ppm, 5850 ppm, 5900 ppm, 5950 ppm, 6000 ppm, 6050 ppm, 6100 ppm, 6150 ppm, 6200 ppm, 6250 ppm, 6300 ppm, 6350 ppm, 6400 ppm, 6450 ppm, 6500 ppm, 6550 ppm, 6600 ppm, 6650 ppm, 6700 ppm, 6750 ppm, 6800 ppm, 6850 ppm, 6900 ppm, 6950 ppm, 7000 ppm, 7050 ppm, 7100 ppm, 7150 ppm, 7200 ppm, 7250 ppm, 7300 ppm, 7350 ppm, 7400 ppm, 7450 ppm, 7500 ppm, 7550 ppm, 7600 ppm, 7650 ppm, 7700 ppm, 7750 ppm, 7800 ppm, 7850 ppm, 7900 ppm, 7950 ppm, 8000 ppm, 8050 ppm, 8100 ppm, 8150 ppm, 8200 ppm, 8250 ppm, 8300 ppm, 8350 ppm, 8400 ppm, 8450 ppm, 8500 ppm, 8550 ppm, 8600 ppm, 8650 ppm, 8700 ppm, 8750 ppm, 8800 ppm, 8850 ppm, 8900 ppm, 8950 ppm, 9000 ppm, 9050 ppm, 9100 ppm, 9150 ppm, 9200 ppm, 9250 ppm, 9300 ppm, 9350 ppm, 9400 ppm, 9450 ppm, 9500 ppm, 9550 ppm, 9600 ppm, 9650 ppm, 9700 ppm, 9750 ppm, 9800 ppm, 9850 ppm, 9900 ppm, 9950 ppm, 10000 ppm.

In another embodiment, the invention is a method for inhibiting the growth of bacteria and/or fungi in a wallboard joint composition during storage. In the method, BIT and one or more carbamodithioic acid metal salts as listed above, such as Ziram, may be added to the wallboard joint compound separately or as a blend to inhibit the growth of microbes such as bacteria and fungi. The BIT and one or more carbamodithioic acid metal salts may be introduced into the wallboard joint compound as a preservative composition that is in the form of a dispersion, which includes BIT and the one or more carbamodithioic acid metal salts, but excludes formaldehyde and FRP's. The dispersion may be aqueous or non-aqueous. Aqueous dispersions are preferred. A non-limiting example of a non-aqueous dispersion is an oil-based dispersion. The total mass of BIT and the one or more carbamodithioic acid metal salts in the preservative composition may be in the range of about 1% to about 90% of the preservative composition, or up to 100% of the preservative composition, or alternatively in the range of about 2% to about 30% of the preservative composition. The mass ratio of BIT to the one or more carbamodithioic acid metal salts in the preservative composition may be in the range of about 0.01:1 to about 100:1, alternatively may be in the range of about 0.1:1 to about 10:1, or may be in the range of about 0.3:1 to about 3:1. For example the mass ratio of BIT to one or more carbamodithioic acid metal salts as listed above, such as Ziram, in the preservative composition may be 0.01:1, 0.05:1, 0.1:1, 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 2.5:1, 3:1, 3.5:1, 4:1, 4.5:1, 5:1, 5.5:1, 6:1, 7:1, 7.5:1, 8:1, 9:1, 11:1, 12:1, 13:1, 14:1, 15:1, 20:1, 25:1, 33:1, 45:1; 50:1, 60:1, 70:1, 80:1, 90:1, 95:1, 100:1, 1:100, 1:95, 1:90, 1:85, 1:80, 1:75, 1:70, 1:65, 1:60, 1:55, 1:50, 1:45, 1:40, 1:35, 1:30, 1:25, 1:20, 1:15, 1:10, 1:9, 1:8, 1:7, 1:6, 1:5, 1:4, 1:3, 1:2.

In another method, the preservative composition which comprises BIT and one or more carbamodithioic acid metal salts is blended into the wallboard joint composition and mixed thoroughly. Use levels for the total mass of active ingredients (i.e., BIT and one or more carbamodithioic acid metal salts as listed above, such as Ziram) based on the mass of the wallboard joint composition are preferably in the range of about 10 to 10,000 ppm weight, depending on the particular ingredients and their history of previous contamination. For example the total amount of the preservative composition disclosed herein that is added to a wallboard joint composition to be protected from microbial growth may comprise 10 parts per million weight (ppm), 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 95 ppm, 100 ppm, 150 ppm, 200 ppm, 250 ppm, 300 ppm, 350 ppm, 400 ppm, 450 ppm, 500 ppm, 550 ppm, 600 ppm, 650 ppm, 700 ppm, 750 ppm, 800 ppm, 850 ppm, 900 ppm, 950 ppm, 1000 ppm, 1050 ppm, 1100 ppm, 1150 ppm, 1200 ppm, 1250 ppm, 1300 ppm, 1350 ppm, 1400 ppm, 1450 ppm, 1500 ppm, 1550 ppm, 1600 ppm, 1650 ppm, 1700 ppm, 1750 ppm, 1800 ppm, 1850 ppm, 1900 ppm, 1950 ppm, 2000 ppm, 2050 ppm, 2100 ppm, 2150 ppm, 2200 ppm, 2250 ppm, 2300 ppm, 2350 ppm, 2400 ppm, 2450 ppm, 2500 ppm, 2550 ppm, 2600 ppm, 2650 ppm, 2700 ppm, 2750 ppm, 2800 ppm, 2850 ppm, 2900 ppm, 2950 ppm, 3000 ppm, 3050 ppm, 3100 ppm, 3150 ppm, 3200 ppm, 3250 ppm, 3300 ppm, 3350 ppm, 3400 ppm, 3450 ppm, 3500 ppm, 3550 ppm, 3600 ppm, 3650 ppm, 3700 ppm, 3750 ppm, 3800 ppm, 3850 ppm, 3900 ppm, 3950 ppm, 4000 ppm, 4050 ppm, 4100 ppm, 4150 ppm, 4200 ppm, 4250 ppm, 4300 ppm, 4350 ppm, 4400 ppm, 4450 ppm, 4500 ppm, 4550 ppm, 4600 ppm, 4650 ppm, 4700 ppm, 4750 ppm, 4800 ppm, 4850 ppm, 4900 ppm, 4950 ppm, 5000 ppm, 5050 ppm, 5100 ppm, 5150 ppm, 5200 ppm, 5250 ppm, 5300 ppm, 5350 ppm, 5400 ppm, 5450 ppm, 5500 ppm, 5550 ppm, 5600 ppm, 5650 ppm, 5700 ppm, 5750 ppm, 5800 ppm, 5850 ppm, 5900 ppm, 5950 ppm, 6000 ppm, 6050 ppm, 6100 ppm, 6150 ppm, 6200 ppm, 6250 ppm, 6300 ppm, 6350 ppm, 6400 ppm, 6450 ppm, 6500 ppm, 6550 ppm, 6600 ppm, 6650 ppm, 6700 ppm, 6750 ppm, 6800 ppm, 6850 ppm, 6900 ppm, 6950 ppm, 7000 ppm, 7050 ppm, 7100 ppm, 7150 ppm, 7200 ppm, 7250 ppm, 7300 ppm, 7350 ppm, 7400 ppm, 7450 ppm, 7500 ppm, 7550 ppm, 7600 ppm, 7650 ppm, 7700 ppm, 7750 ppm, 7800 ppm, 7850 ppm, 7900 ppm, 7950 ppm, 8000 ppm, 8050 ppm, 8100 ppm, 8150 ppm, 8200 ppm, 8250 ppm, 8300 ppm, 8350 ppm, 8400 ppm, 8450 ppm, 8500 ppm, 8550 ppm, 8600 ppm, 8650 ppm, 8700 ppm, 8750 ppm, 8800 ppm, 8850 ppm, 8900 ppm, 8950 ppm, 9000 ppm, 9050 ppm, 9100 ppm, 9150 ppm, 9200 ppm, 9250 ppm, 9300 ppm, 9350 ppm, 9400 ppm, 9450 ppm, 9500 ppm, 9550 ppm, 9600 ppm, 9650 ppm, 9700 ppm, 9750 ppm, 9800 ppm, 9850 ppm, 9900 ppm, 9950 ppm, 10000 ppm of the wallboard joint composition.

Preservative compositions are often called upon to protect against one or more unidentified microbes that are encountered in a particular application. To the extent that microbial growth as a whole is inhibited in the particular application, the preservative composition is considered successful. The identity of the microbe whose growth is inhibited may remain undetermined.

The inventors have found that the preservative composition of the present invention synergistically inhibits the growth of bacteria, such as Pseudomonas aeruginosa. This particular bacteria was selected because it is a relatively difficult to inhibit and consequently, it is widely accepted that preservative compositions which are effective against Pseudomonas aeruginosa are broadly effective against many types of bacteria. As described below in the Examples, experimental results demonstrate that the Minimum Inhibitory Concentrations (“MIC”) of BIT and Ziram, respectively, against Pseudomonas aeruginosa are 30.84 ppm and 32.41 ppm. Blends of these actives having BIT:Ziram ratios (or the ratio of BIT to one or more carbamodithioic acid metal salts ratios as listed above) in the range of 3:1 to 1:3 demonstrated significantly lower MIC throughout the range. Without intending to limit the scope of the invention in any way, it is expected that the blend of BIT with one or more carbamodithioic acid metal salts disclosed herein will inhibit the growth of many objectionable bacteria that are capable of causing degradation to highly susceptible materials.

Other biologically active ingredients, as well as adjuvants such as surfactants, thickeners, defoamers, pH buffering agents, and solvents, can be successfully included in the inventive preservative composition.

The surprising inhibitory activity of the preservative composition (i.e., BIT together with one or more carbamodithioic acid metal salts) as disclosed herein is a synergistic effect, which can be determined experimentally and quantified in terms of its Synergy Index. Although the present invention is not limited to binary systems having exactly two biologically active materials, the definitions of “synergistic effect” and “Synergistic Index” proposed by F. C. Kull et al. for binary systems are hereby adopted for aspects of the present invention which are binary systems. These concepts have more recently been expanded to include tertiary systems and other multi-component systems, by methods which are known to practitioners in the field of preservative biology.

For binary systems, “Synergistic effect” means that the response of a mixture of two components is greater than the sum of the response of the individual components. A mathematical approach for assessing synergy is reported by F. C. Kull, P. C. Elisman, H. D. Sylwestrowicz and P. K. Mayer, in Applied Microbiology, 9:538 (1961). For binary mixtures, “Synergistic Index” is defined by the following equation.

Synergistic Index=Qa/QA+Qb/QB [Equation No. 1]

Where:

Qa=the quantity of component A used in a binary mixture that gives the desired effect;

QA=the quantity of component A which when used alone gives the desired effect;

Qb=the quantity of component B used in a binary mixture that gives the desired effect; and

QB=the quantity of component B which when used alone gives the desired effect.

For the present purposes, the following definitions may be used:
“Antimicrobial” means a material that is biologically active for inhibiting the growth of microbes.
“Antibacterial” means a material that is biologically active for inhibiting the growth of certain bacteria.
“Antifungal” means a material that is biologically active for inhibiting the growth of fungi (including fungi such as mildew and yeast).
“Preservative” means a material that is biologically active for inhibiting the growth of bacteria, algae, or fungi (including fungi such as mildew and yeast).
“Microbe” means a unicellular life form.
“Minimum Inhibitory Concentration” or “MIC” means the minimum concentration necessary to inhibit the growth of a microbe under standardized test conditions.
“Mastic” means an adhesive for use in the construction industry on porcelain, glass, or ceramic tile. Mastic as used herein may be a high-grade construction adhesive commonly used to bond ceiling, wall, and floor tiles, plywood panels, concrete, asphalt, leather and fabric. Mastic as used herein may be a waterproof, putty-like paste used in buildings as a joint-sealer or filler. Older tile mastics were derived from the resin of the Pistacia lentiscus tree. Today, many mastics are asphalt-based organic materials or inorganic acrylic copolymers mixed with calcium carbonate.
“Wallboard joint compound” or “joint compound” (also called drywall compound or mastic or drywall joint compound or wallboard mud) is a white powder of primarily gypsum (hydrated calcium sulfate), limestone, relatively small proportions of stone, clay, and a polymer mixed with water to form a mud the consistency of cake frosting, which is used with paper or fiber joint tape to seal joints between sheets of drywall (also known as wallboard plasterboard or sheetrock) to create a seamless base for paint on interior walls. As used herein, the terms “wallboard joint compound” or “joint compound” refer to the mud formed after the addition of water.
“Pulp and paper slurry” means a liquid mixture comprising pulp fibers, fillers, coating pigments and other solid material suspended in water or adhesive as used in the papermaking process.
“Mineral slurry” means a mixture of mineral solids with specific gravity greater than 1 suspended in liquid, usually water. These are typically used in the field of coal or ore refining, but may also be used for instance, as an abrasive polish.
“Asphalt emulsion” means a liquid asphalt cement emulsified in water. It comprises asphalt, water and an emulsifying agent.
“Includes” means comprises but is not limited to.
“Excludes” or “essentially no” means that some amount present may be present as an impurity but no more than the minimum level consistent with present good manufacturing practices.
The notation “BIT:Ziram” or “BIT:Thiram”, or “BIT:any other metal salt of a carbamodithioic acid” means that the recited components are both present in a composition and are present in some weight ratio to each other.
   Various exemplary aspects of the invention may be summarized as follows:
   Aspect 1: A preservative composition, which comprises:

1,2-benzisothiazol-3(2H)-one (“BIT”), and

a metal salt of a carbamodithioic acid.

Aspect 2: The preservative composition according to Aspect 1, wherein the metal salt of a carbamodithioic acid is selected from the group consisting of: sodium N-methylcarbamodithioate (“Metam Sodium”); potassium N-methylcarbamodithioate (“Metam Potassium”); zinc N,N-dimethylcarbamodithioate (“Ziram”); sodium N,N-dimethylcarbamodithioate (“Dibam”); potassium N,N-dimethylcarbamodithioate (“Dibam Potassium”); dimethylcarbamothioylsulfanyl N,N-dimethylcarbamodithioate (“Thiram”); zinc N-[2-(sulfidocarbothioylamino)ethyl]carbamodithioate (“Zineb”); disodium N-[2-(sulfidocarbothioylamino)ethyl]carbamodithioate (“Nabam”); zinc, manganese(2+)N-[2-(sulfidocarbothioylamino)ethyl]carbamodithioate (“Mancozeb”); manganese(2+)N-[2-(sulfidocarbothioylamino)ethyl]carbamodithioate (“Maneb”); zinc N-[1-(sulfidocarbothioylamino)propan-2-yl]carbamodithioate (“Propineb”); tetrahydro-3,5-dimethyl-2H-1,3,5-thiadiazin-2-thion (“Dazomet”); and mixtures thereof.
Aspect 3: The preservative composition according to any of Aspects 1 and 2, wherein the metal salt of a carbamodithioic acid is selected from the group consisting of Dibam, Dibam Potassium, Ziram, Thiram, and a mixture thereof.
Aspect 4: The preservative composition according to any of Aspects 1-3, wherein the metal salt of a carbamodithioic acid is Ziram.
Aspect 5: The preservative composition according to any of any of Aspects 1-4, wherein the preservative composition inhibits bacterial growth.
Aspect 6: The preservative composition according any of Aspects 1-5, wherein the preservative composition inhibits bacterial growth and inhibits fungal growth.
Aspect 7: The preservative composition according to any of Aspects 1-6, wherein the preservative composition inhibits the growth of Alcaligenes faecalis, Enterobacter aerogenes, Escherichia coli, or Pseudomonas aeruginosa bacteria.
Aspect 8: The preservative composition according to any of Aspects 1-7, wherein the preservative composition synergistically inhibits the growth of Pseudomonas aeruginosa bacteria.
Aspect 9: The preservative composition according to any of Aspects 1-8, wherein the preservative composition excludes formaldehyde or formaldehyde-releasing products.
Aspect 10: The preservative composition according to any of Aspects 1-9, wherein the preservative composition is suitable for use in a wallboard joint compound, a pulp and paper slurry, a mineral slurry, an asphalt emulsion, a mastic, or a mixture of thereof.
Aspect 11: A wallboard joint compound, a pulp and paper slurry, a mineral slurry, an asphalt emulsion, or a mastic, which comprises the preservative composition of any of Aspects 1-10.
Aspect 12: A method for inhibiting the growth of bacteria in a material during storage, or for inhibiting the growth of fungi in a material during storage, or for inhibiting the growth of bacteria and fungi in a material during storage, wherein the material is selected from the group consisting of a wallboard joint compound, a pulp and paper slurry, a mineral slurry, an asphalt emulsion, and a mastic, wherein the method comprises the steps of:

a) introducing BIT and a metal salt of a carbamodithioic acid into the material, to produce a protected material; and

b) thoroughly mixing the protected material.

Aspect 13: The method according to Aspect 12, wherein the metal salt of a carbamodithioic acid is selected from the group consisting of: sodium N-methylcarbamodithioate (“Metam Sodium”); potassium N-methylcarbamodithioate (“Metam Potassium”); zinc N,N-dimethylcarbamodithioate (“Ziram”); sodium N,N-dimethylcarbamodithioate (“Dibam”); potassium N,N-dimethylcarbamodithioate (“Dibam Potassium”); dimethylcarbamothioylsulfanyl N,N-dimethylcarbamodithioate (“Thiram”); zinc N-[2-(sulfidocarbothioylamino)ethyl]carbamodithioate (“Zineb”); disodium N-[2-(sulfidocarbothioylamino)ethyl]carbamodithioate (“Nabam”); zinc, manganese(2+)N-[2-(sulfidocarbothioylamino)ethyl]carbamodithioate (“Mancozeb”); manganese(2+)N-[2-(sulfidocarbothioylamino)ethyl]carbamodithioate (“Maneb”); zinc N-[1-(sulfidocarbothioylamino)propan-2-yl]carbamodithioate (“Propineb”); tetrahydro-3,5-dimethyl-2H-1,3,5-thiadiazin-2-thion (“Dazomet”); and mixtures thereof.
Aspect 14: The method according to any of Aspects 12 and 13, wherein the metal salt of a carbamodithioic acid is selected from the group consisting of Dibam, Dibam Potassium, Ziram, Thiram, and mixtures thereof.
Aspect 15: The method according to any of Aspects 12-14, wherein the metal salt of a carbamodithioic acid is Ziram.
Aspect 16: The method according to any of Aspects 12-15, wherein the growth of bacteria is inhibited.
Aspect 17: The method according to any of Aspects 12-16, wherein the growth of bacteria and fungi are inhibited.
Aspect 18: The method according to any of Aspects 12-17, wherein the growth of Alcaligenes faecalis, Enterobacter aerogenes, Escherichia coli, and Pseudomonas aeruginosa bacteria are inhibited.
Aspect 19: The method according to any of Aspect 12-18, wherein the growth of Pseudomonas aeruginosa bacteria is synergistically inhibited.
Aspect 20: The method according to any of Aspects 12-19, wherein the protected material excludes formaldehyde or formaldehyde-releasing products.
Aspect 21: The method according to any of Aspects 12-20, wherein the selected material is selected from the group consisting of a wallboard joint compound, a mineral slurry, a mastic, and mixtures thereof.
Aspect 22: The method according to any of Aspects 12-21, wherein the selected material is a wallboard joint compound.
Aspect 23: A protected material manufactured by the method according to any of Aspects 12-22, wherein the metal salt of a carbamodithioic acid is selected from the group consisting of Dibam, Dibam Potassium, Ziram, Thiram, and mixtures thereof.
Aspect 24: The protected material manufactured by the method according to any of Aspects 1-23, wherein the metal salt of a carbamodithioic acid is Ziram.

### EXAMPLES

The following examples are presented to better communicate the invention, and are not intended to limit the invention in any way. Unless otherwise indicated, all references to parts, percentages, fractions, or proportions are based on mass.

### Example 1: Minimum Inhibitory Concentration (“MIC”) Testing

A) Preparation of Active Preservative Blends for MIC Testing

Measured masses of Ziram, commercially available from Sigma-Aldrich, Sigma-Aldrich Corporation, St. Louis, Mo., USA as Product Number 329711, and BIT, commercially available from Troy Corporation, Florham Park, N.J. 07932, U.S.A. as Mergal® BIT20W, were mixed in the proportions indicated to obtain blends having the Ziram to BIT Ratios shown in Table 1.

TABLE 1

| | Blend | Blend | Blend | Blend | Blend |
|---|---|---|---|---|---|
| Product | No. 1 | No. 2 | No. 3 | No. 4 | No. 5 |
| Ziram to BIT Ratio | 1 to 3 | 1 to 2 | 1 to 1 | 2 to 1 | 3 to 1 |
| by weight | | | | | |
| Total Active Content in | 19.99% | 20.21% | 20.64% | 21.10% | 21.34% |
| Blend: Total of BIT and | | | | | |
| Ziram, weight % | | | | | |

Blends No. 1 through 5 were subsequently diluted with deionized water to 2.00% total active content so that MIC values could be measured by the well-known microbroth dilution method, as described below. Active concentrations in these diluted blends were checked for accuracy by HPLC analysis before use.

B) MIC Testing of Diluted Active Blends

The MIC of each of the diluted blends described above was determined via microbroth dilution using the specific test parameters set forth below in Table 2:

TABLE 2

| Test Parameter | Specific Value |
|---|---|
| Test Organism: | Pseudomonas aeruginosa (ATCC #10145) |
| Format | 96 well plate |
| Strength: | 1 × 10⁵ CFU/mL |
| Standardization: | OD₆₀₀ |
| Incubation Temperature: | 35° C. |
| Incubation Time: | 3 days |
| Test Endpoint: | No growth (via turbidity) |
| Test Media: | 1x Nutrient Broth |

Biocide dilutions were performed in either 2 or 0.75 dilutions. Organism dilutions via OD₆₀₀ were calculated based on OD₆₀₀ of 1.0 being equivalent to 8×10⁸ CFU/mL. MIC measurements were performed with 11-12 replicates (3 technical replicates, 4 biological replicates).

C) Results for MIC Testing of Diluted Active Blends

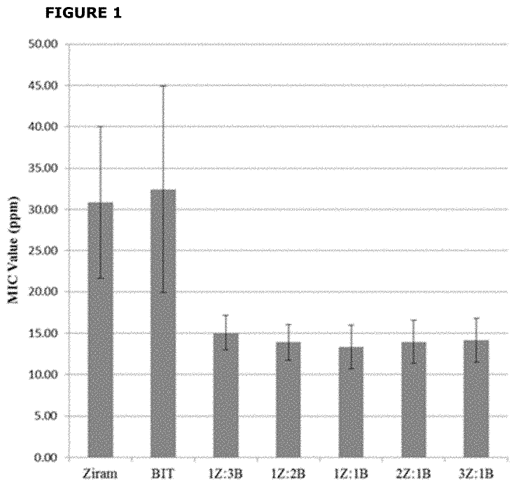

The hallmark of most effective preservatives is their ability to leverage synergy to allow end-users to use less total active ingredient without a loss in performance. The results for MIC Testing of the diluted active blends described above are presented in FIG. 1.

The data in FIG. 1 demonstrates that the MIC values for Ziram and BIT alone are 32.41 ppm and 30.84 ppm, respectively. The MICs for blends of these actives over the range of ratios ranging from 3:1 to 1:3 mass ratio (BIT:Ziram) exhibited significantly lower values of MIC in the range of 13.91 to 15.07 ppm, as shown in FIG. 1.

Inspection of FIG. 1 reveals that blends of Ziram and BIT are more effective in combination than either Ziram or BIT alone against Pseudomonas aeruginosa, ATCC #10145. In FIG. 1 the blends are coded by their individual weight ratios of Ziram:BIT, where “Z” denotes Ziram and “B” denotes BIT. For example, “1Z:3B” denotes a blend having a Ziram:BIT mass ratio of 1:3. Additionally, FIG. 1 depicts error bars for the active compounds alone and in blends containing both active components. Each error bar represents a standard deviation of MIC, based on 11 to 12 replicates.

Next, the Synergy Index (“S.I.”) of each preservative blend was calculated by the following formula:

S.I.=[MIC_{[BIT]in blend}/MIC_{[BIT]alone}]+[MIC_{[ziram]in blend}/MIC_{[ziram]alone}].

Synergy Index values are sometimes referred to as “Fractional Inhibitory Concentration”. By definition, Synergy Indices which are less than 1 demonstrate synergism, greater than 1 demonstrate antagonism, and equal to 1 demonstrate purely additive properties. Synergy indices of significantly less than 1 are preferred.

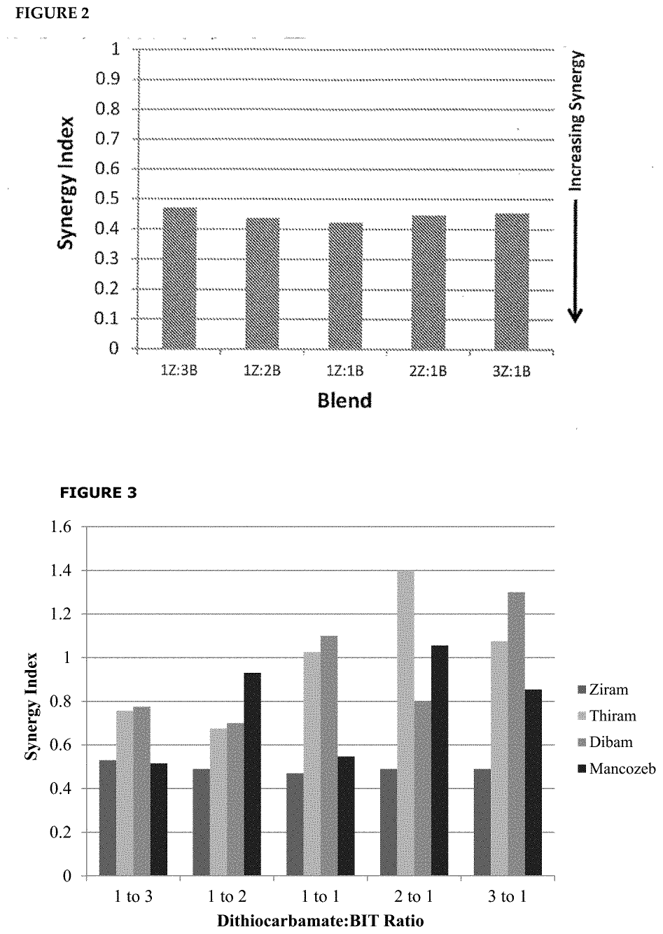

The calculated Synergy Indexes are presented graphically in FIG. 2, which is a column chart showing the average value for each of the diluted blends and the active components based on hundreds of repetitions. Consistent with the data presented FIG. 1, the calculated average Synergy Indices of FIG. 2 range from 0.42 to 0.48. These results indicated that all five of the tested blends are highly synergistic.

Based on the results depicted in FIG. 2, every blend of BIT and Ziram having a Ziram:BIT ratio in the range of 0.33:1 to 3.0:1 is more than twice as effective against Pseudomonas aeruginosa as the same total amount of these preservatives when applied separately.

### Example 2: Bacterial Challenge Test of 1:1 Ziram:BIT Blend in Laboratory-Made Wallboard Joint Compound

A) Preservative Blend Preparation for Bacterial Challenge Test

Bacterial challenge testing was performed using common industrial contaminants Alcaligenes faecalis (ATCC #25094), Enterobacter aerogenes (ATCC #13048), Escherichia coli (ATCC #11229), and Pseudomonas aeruginosa (ATCC #10145).

To increase the relevance of the challenge study to wallboard joint compound manufacturing, an industrially relevant strain of Pseudomonas sp. found at several distinct wallboard joint compound manufacturing sites was also included in the bacterial inoculum. To prepare this challenge inoculum, all bacteria were blended from overnight cultures on Plate Count Agar (PCA), lifted from the plate with sterile cotton swabs into 1× Butterfield's Phosphate Buffer (pH 7.2) and then mixed at equal colony forming unit (CFU) via OD₆₀₀ measurements, then diluted to OD₆₀₀=0.7 (˜10⁸ CFU/mL) in order to create the final bacterial consortia. This bacterial mixture was prepared shortly before each of four inoculations. Inoculations were performed by adding 0.5 mL of the mixed inoculum to 50 g of the indicated test sample, providing approximately 10⁶ CFU/g per challenge. Streaks were then done 1, 2, and 7 days after inoculum onto Plate Count Agar (PCA) and incubated at 28° C. for 1 week before semi-quantitative readings were evaluated and recorded as the average of two duplicate readings from “0” to “4”, in accordance with Table 3, below.

TABLE 3

| Bacterial Colony Count | Rating | Approximate CFU/g |
|---|---|---|
| 0 | 0 | <1 |
| 1-10 | 1 | 10-10² |
| 11-100 | 2 | 10³-10⁴ |
| 101-1000 | 3 | 10⁴-10⁵ |
| >1000 | 4 | >10⁵ |

B) Laboratory-Made Wallboard Joint Compound Composition for Bacterial Challenge Test

The composition of the wallboard joint compound as made in the laboratory, which was used in the first Bacterial Challenge Test is presented below in Table 4.

TABLE 4

| Ingredient | Mass (%) |
|---|---|
| Limestone | 39.3 |
| Attapulite Clay | 3 |
| Mica | 4 |
| Latex emulsion | 2.5 |
| Water-soluble polymer | 0.5 |
| Defoamer | 0.1 |
| Water | 42 |
| Total | 100.0 |

C) Results of Bacterial Challenge for 1:1 Ziram:BIT in Unpreserved Laboratory-Made Wallboard Joint Compound

Preservative blends often show efficacy in microbroth dilution, but fail to demonstrate efficacy when formulated into the target matrix. For this reason, the efficacy of a 1:1 ratio blend of BIT:Ziram was determined in a typical wallboard joint compound with rigorous bacterial challenge testing. Wallboard joint compound was selected as a suitable test matrix because it is particularly susceptible to microbial degradation and therefore is considered difficult to preserve, even for typical formaldehyde producing preservatives.

Because this bacterial challenge test is intended to test the performance of in-can preservatives during long-term storage, only the last day of each seven-day challenge is considered important. The test sample was inoculated with bacteria on the first day of each seven-day challenge.

Bacteria were inoculated into the laboratory-made test wallboard joint formulations at approximately 10⁶ CFU/g at time equals zero on the first day of each seven-day cycle. Viability of the bacteria was monitored semi-quantitatively through streak analysis 1, 2, and 7 days after inoculation. This procedure was performed twice for a total of two to four seven-day cycles. A rating of “4” indicates heavy growth, while a rating of “0” indicates undetectable growth, defined as <10 CFU/g of material. Samples free of detectable growth after 7 days are considered to be well-preserved.

The rigor of this bacterial challenge testing method was increased to ensure that the preservatives would be functional and effective in the field by incorporating an industrially relevant Pseudomonas sp. contaminant isolated from various U.S. and Canadian joint compound manufacturing facilities in the challenge mixture.

A 1:1 Ziram:BIT blend containing 20% total active materials was created by mixing 1.08 g of Mergal® BIT20W (commercially available from Troy Corporation of Florham Park, N.J. 07932, United States of America) and 0.92 g of a 22.1% Ziram dispersion. The resulting mixture is a 20.64% wt active product containing an equal mass ratio of BIT and Ziram. This product was then dosed into the laboratory-made unpreserved wallboard joint compound as shown in Table 4, at dosages ranging from 0.10 to 0.25% w/w of the 20.64 wt % active. For comparison, a blank, unpreserved laboratory-made wallboard joint composition is shown, as well as a laboratory-made wallboard joint composition that is preserved with a commercial formaldehyde-producing preservative, comprising 78 wt % of 2,2′,2″-(hexahydro-1,3,5-triazine-1,3,5-triyl)-triethanol (HHT). The various preservatives were added to the laboratory-made wallboard joint compound at the levels shown, in ppm by weight.

The results of the bacterial challenge tests are presented below in Table 5.

TABLE 5

| | Active | Challenge | | | Challenge | | | | Challenge | | | Challenge | | |
|---|---|---|---|---|---|---|---|---|---|---|---|---|---|---|
| | (ppm | #1 | | | #2 | | | | #3 | | | #4 | | |
| Test Sample | wt) | 1 d | 2 d | 7 d | 1 d | 2 d | 7 d | | 1 d | 2 d | 7 d | 1 d | 2 d | 7 d |
| Blank F1709 | 0 | | | | | | | Heat Age, | | | | | | |
| DL1645-27 Joint | | | | | | | | 1 Week at 40° C. | | | | | | |
| Compound | | | | | | | | | | | | | | |
| +0.078 wt % HHT | 780 | 1 | 1 | | | | | | | | | | | |
| COMPARATIVE | | | | | | | | | | | | | | |
| +0.12 wt % HHT | 1170 | 0 | 0 | 2 | | | | | | 3 | 0 | | | 1 |
| COMPARATIVE | | | | | | | | | | | | | | |
| +0.16 wt % HHT | 1560 | 0 | 0 | 0 | 0 | 0 | 0 | | 0 | 0 | 0 | 0 | 0 | 0 |
| COMPARATIVE | | | | | | | | | | | | | | |
| +0.20 wt % HHT | 1950 | 0 | 0 | 0 | 0 | 0 | 0 | | 0 | 0 | 0 | 0 | 0 | 0 |
| COMPARATIVE | | | | | | | | | | | | | | |
| +0.10 wt % ZB- | 206 | 2 | 0 | 0 | 3 | 0 | 0 | | 3 | 3 | | | | |
| 1:1 | | | | | | | | | | | | | | |
| INVENTION | | | | | | | | | | | | | | |
| +0.15 wt % ZB- | 310 | 2 | 0 | 0 | 3 | 0 | 0 | | 2 | 1 | | | | |
| 1:1 | | | | | | | | | | | | | | |
| INVENTION | | | | | | | | | | | | | | |
| +0.20 wt % ZB- | 413 | 0 | 0 | 0 | 2 | 0 | 0 | | 1 | 0 | 0 | 0 | 0 | 0 |
| 1:1 | | | | | | | | | | | | | | |
| INVENTION | | | | | | | | | | | | | | |
| +0.25 wt % ZB- | 516 | 0 | 0 | 0 | 2 | 0 | 0 | | 0 | 0 | 0 | 0 | 0 | 0 |
| 1:1 | | | | | | | | | | | | | | |
| INVENTION | | | | | | | | | | | | | | |

Inspection of Table 5 reveals that the bacterial challenge testing demonstrates excellent performance in a wallboard joint compound. The data indicates that 1:1 Ziram:BIT blend at 20% active concentration exhibited excellent in-can preservative performance throughout four seven-day challenges in a laboratory-made wallboard joint compound. Next, to confirm that the synergy observed in broth experiments against Pseudomonas (Example 1) held true in wallboard joint compound, the challenge testing was repeated at one level and compared to the performance of BIT and Ziram alone. Bacterial resistance was again assessed using the same testing as described above. This testing reaffirms that the strong synergy of BIT and Ziram observed in MIC testing (Example 1) translates well into wallboard joint compound, with neither 200 ppm BIT nor Ziram alone being capable of protecting the wallboard joint compound on their own, but the 200 ppm total of BIT with Ziram combination showing strong activity (Table 6). As shown in Table 6, BIT and Ziram are synergistic in wallboard joint compound. The bacterial challenge testing was carried out as outlined above.

TABLE 6

| | Active | Challenge #1 | | | Challenge #2 | | |
|---|---|---|---|---|---|---|---|
| Test Sample | (ppm) | 1 d | 2 d | 7 d | 1 d | 2 d | 7 d |
| Laboratory-Made Wallboard | 0 | 4 | 4 | 4 | 4 | 4 | 4 |
| Joint Compound, no | | | | | | | |
| preservative (Blank) | | | | | | | |
| +0.10% Mergal ® BIT20W | 200 | 1 | 0 | 1 | 2 | 4 | 4 |
| +0.10% Ziram | 200 | 4 | 4 | 4 | 4 | 4 | 4 |
| +0.10% Ziram:BIT (1:1) | 200 | 1 | 0 | 0 | 0 | 0 | 0 |

### Example 3: Evaluation of Various Dithiocarbamate:BIT Blends at Various Ratios for Synergy and Performance in a Joint Compound

Additional Dithiocarbamate and BIT blends were also tested to determine the Synergy Index for various compounds at various mass ratios with BIT. The performance of Mergal® 174II (Troy Corporation) which represents the typical performance form a formaldehyde-producing preservative, was used as a performance benchmark due to its successful use as a preservative for joint compound for decades. The dithiocarbamates shown in Table 7 below were tested:

TABLE 7

| | | Active | |
|---|---|---|---|
| | | Content in | |
| Preservative | | Solution | |
| 1,2-benzisothiazol-3(2H)-one | (BIT) Mergal ® | 19.40 | weight % |
| | BIT20W (Troy) | | |
| 2,2′,2″-(hexahydro-1,3,5-triazine-1,3,5- | Mergal ® 174II | 78 | weight % |
| triyl)triethanol (HHT) | (Troy) | | |
| sodium N,N-dimethylcarbamodithioate | Dibam (Sigma | 40 | volume % |
| | Aldrich) | | |
| Zinc N,N-dimethylcarbamodithioate | Ziram Dispersion | 22.1 | weight % |
| | (Troy | | |
| | Experimental) | | |
| dimethylcarbamothioylsulfanyl N,N- | Thiram (Sigma | 97 | weight % |
| dimethylcarbamodithioate | Aldrich) | | |
| Zinc, manganese(2+) N-[2- | Mancozeb | 37 | weight % |
| (sulfidocarbothioylamino)ethyl]carbamodithioate) | (Bonide Chemical) | | |

Minimum inhibitory concentrations were determined by the microbroth dilution method described previously on two-fold dilutions of the indicated preservatives. Bacterial challenge studies were performed in accordance with the method shown in Example 2 with inclusion of a Pseudomonas sp. isolate. Because Ziram and BIT were the most significantly synergistic in previous testing, the effectiveness of 1:1 blends of BIT with other dithiocarbamates was assayed with a more rigorous bacterial challenge study employing 4 challenges and 1 week of heat-aging at 40° C. A sample of unpreserved wallboard joint compound was obtained from an industrial source. This commercial wallboard joint compound has a slightly different composition than the laboratory-made wallboard joint compound used in Example 2. Testing a slightly different wallboard joint composition tests the efficacy of the preservatives in a variety of compositions. The commercial unpreserved wallboard joint compound sample was free of detectable growth (<10 CFU/mL) before the test was initiated. The test was carried out according to the following procedure:

Bacterial challenge testing was performed using common industrial contaminants Alcaligenes faecalis (ATCC #25094), Enterobacter aerogenes (ATCC #13048), Escherichia coli (ATCC #11229), Pseudomonas aeruginosa (ATCC #10145). To increase the relevance of the challenge study to wallboard joint compound manufacturing, an industrially relevant strain of Pseudomonas sp. found at several joint compound manufacturing sites was also included in the bacterial inoculum, as in Example 2. All bacteria were blended from overnight cultures on Plate Count Agar (PCA) and mixed at equal CFU via OD₆₀₀ measurements, then diluted to OD₆₀₀=0.7 (approximately 10⁹ CFU/mL) to create the final bacterial consortia. This bacterial mixture was prepared shortly before each of the 4 inoculations. Inoculations were performed by adding 0.5 mL to 50 g of the indicated test sample, providing approximately 10⁷ CFU/g per challenge. Streaks were then done 1, 2, and 7 days onto PCA and incubated at 28° C. for 1 week before semi-quantitative readings were evaluated and recorded as the average of two duplicate readings from “0” to “4” in the same ratings system as described above with Table 3.

Challenge testing revealed that 1:1 blends of BIT and any of the dithiocarbamate compounds, Thiram, Dibam, and Mancozeb, were capable of high-performance preservation of the joint compound, but varied in the levels required for full protection through the test protocol. The strongest activity was observed with BIT:Ziram or BIT:Mancozeb, both of which survived 4 challenges at 0.10 weight % (200 ppm total of active). Blends containing dithiocarbamates BIT:Thiram or BIT:Dibam required 0.20 weight % in total to achieve the same level of protection as shown in Table 8 for BIT:Ziram, but nevertheless are effective preservatives and exhibit synergy. Blends of BIT and several dithiocarbamates are therefore effective wallboard joint compound preservatives at a ratio of 1:1. All test preservatives were prepared with equal levels of BIT and the indicated dithiocarbamate to 20 wt/wt % active.

TABLE 8

| | | Challenge | | | Challenge | | | | Challenge | | | Challenge | | |
|---|---|---|---|---|---|---|---|---|---|---|---|---|---|---|
| | Active | #1 | | | #2 | | | | #3 | | | #4 | | |
| Test Sample | (ppm) | 1 d | 2 d | 7 d | 1 d | 2 d | 7 d | | 1 d | 2 d | 7 d | 1 d | 2 d | 7 d |
| Commercial | 0 | 4 | 4 | 4 | 4 | 4 | 4 | Heat Age, | 4 | 4 | 4 | 4 | 4 | 4 |
| Unpreserved | | | | | | | | 1 Week at 40° C. | | | | | | |
| Joint Compound | | | | | | | | | | | | | | |
| comparative | | | | | | | | | | | | | | |
| +0.10% | 200 | 1 | 0 | 0 | 2 | 0 | 0 | | 2 | 1 | 0 | 3 | 0 | 0 |
| Ziram:BIT | | | | | | | | | | | | | | |
| invention | | | | | | | | | | | | | | |
| +0.15% | 300 | 1 | 0 | 0 | 2 | 0 | 0 | | 2 | 1 | 0 | 3 | 0 | 0 |
| Ziram:BIT | | | | | | | | | | | | | | |
| invention | | | | | | | | | | | | | | |
| +0.20% | 400 | 1 | 0 | 0 | 1 | 0 | 0 | | 1 | 0 | 0 | 1 | 0 | 0 |
| Ziram:BIT | | | | | | | | | | | | | | |
| invention | | | | | | | | | | | | | | |
| +0.10% | 200 | 2 | 1 | 1 | 4 | 4 | 4 | | 4 | 4 | 4 | 4 | 4 | 4 |
| Dibam:BIT | | | | | | | | | | | | | | |
| invention | | | | | | | | | | | | | | |
| +0.15% | 300 | 2 | 0 | 0 | 2 | 2 | 4 | | 2 | 1 | 0 | 4 | 4 | 4 |
| Dibam:BIT | | | | | | | | | | | | | | |
| invention | | | | | | | | | | | | | | |
| +0.20% | 400 | 1 | 0 | 0 | 2 | 1 | 0 | | 2 | 1 | 0 | 2 | 0 | 0 |
| Dibam:BIT | | | | | | | | | | | | | | |
| invention | | | | | | | | | | | | | | |
| +0.10% | 200 | 3 | 1 | 0 | 3 | 1 | 1 | | 2 | 0 | 4 | 4 | 4 | 4 |
| Thiram:BIT | | | | | | | | | | | | | | |
| invention | | | | | | | | | | | | | | |
| +0.15% | 300 | 3 | 1 | 0 | 2 | 1 | 0 | | 2 | 0 | 0 | 2 | 1 | 4 |
| Thiram:BIT | | | | | | | | | | | | | | |
| invention | | | | | | | | | | | | | | |
| +0.20% | 400 | 2 | 0 | 0 | 0 | 0 | 0 | | 0 | 0 | 0 | 1 | 0 | 0 |
| Thiram:BIT | | | | | | | | | | | | | | |
| invention | | | | | | | | | | | | | | |
| +0.10% | 200 | 0 | 0 | 0 | 0 | 0 | 0 | | 1 | 0 | 0 | 2 | 0 | 0 |
| Mancozeb:BIT | | | | | | | | | | | | | | |
| invention | | | | | | | | | | | | | | |
| +0.20% | 400 | 0 | 0 | 0 | 0 | 0 | 0 | | 0 | 0 | 0 | 2 | 0 | 0 |
| Mancozeb:BIT | | | | | | | | | | | | | | |
| invention | | | | | | | | | | | | | | |

Finally, to determine whether improvements in the activity of the 1:1 BIT and dithiocarbamate blends were possible to achieve at different ratios, MIC testing was performed on blends of BIT and selected dithiocarbamates against Pseudomonas aeruginosa (ATCC #10145). MIC testing was carried out as described in Example 1. Synergy values were calculated using the formula:

Synergy Index (S.I.)=[MIC_{[BIT]in blend}/MIC_{[BIT]alone}]+[MIC_{[DTC]in blend}/MIC_{[DTC]alone}].

“DTC” in the above formula is an abbreviation for dithiocarbamate, i.e., any of the various tested compounds. Synergy Index values of less than 1 demonstrates synergism, while Synergy Index values greater than 1 demonstrates antagonism. A Synergy Index equal to 1 demonstrates purely additive properties. The results of this testing are shown in FIG. 3.

Evaluations of the performance of various 1:1 blends of BIT with other dithiocarbamates showed good performance, but BIT:Dibam or BIT:Thiram required twice the level needed for BIT:Ziram to pass the challenge, as shown Table 8. The blends containing BIT:Ziram or BIT:Mancozeb were strongly synergistic at the 1:1 mass ratio and showed good performance in the joint compound. The other dithiocarbamates tested in combination with BIT demonstrated optimal synergy at other ratios as well.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A preservative composition, which comprises:
1,2-benzisothiazol-3(2H)-one (“BIT”), and
a metal salt of a carbamodithioic acid.

2. The preservative composition according to claim 1, wherein the metal salt of a carbamodithioic acid is selected from the group consisting of: sodium N-methylcarbamodithioate (“Metam Sodium”); potassium N-methylcarbamodithioate (“Metam Potassium”); zinc N,N-dimethylcarbamodithioate (“Ziram”); sodium N,N-dimethylcarbamodithioate (“Dibam”); potassium N,N-dimethylcarbamodithioate (“Dibam Potassium”); dimethylcarbamothioylsulfanyl N,N-dimethylcarbamodithioate (“Thiram”); zinc N-[2-(sulfidocarbothioylamino)ethyl]carbamodithioate (“Zineb”); disodium N-[2-(sulfidocarbothioylamino)ethyl]carbamodithioate (“Nabam”); zinc, manganese(2+)N-[2-(sulfidocarbothioylamino)ethyl]carbamodithioate (“Mancozeb”); manganese(2+)N-[2-(sulfidocarbothioylamino)ethyl]carbamodithioate (“Maneb”); zinc N-[1-(sulfidocarbothioylamino)propan-2-yl]carbamodithioate (“Propineb”); tetrahydro-3,5-dimethyl-2H-1,3,5-thiadiazin-2-thion (“Dazomet”); and mixtures thereof.

3. The preservative composition according to claim 1, wherein the metal salt of a carbamodithioic acid is selected from the group consisting of Dibam, Dibam Potassium, Ziram, Thiram, and any mixture thereof.

4. The preservative composition according to claim 1, wherein the metal salt of a carbamodithioic acid is Ziram.

5. The preservative composition according to claim 1, wherein the preservative composition inhibits bacterial growth.

6. The preservative composition according claim 1, wherein the preservative composition inhibits bacterial growth and inhibits fungal growth.

7. The preservative composition according to claim 1, wherein the preservative composition inhibits the growth of Alcaligenes faecalis, Enterobacter aerogenes, Escherichia coli, or Pseudomonas aeruginosa bacteria.

8. The preservative composition according to claim 1, wherein the preservative composition synergistically inhibits the growth of Pseudomonas aeruginosa bacteria.

9. The preservative composition according to claim 1, wherein the preservative composition includes essentially no formaldehyde or formaldehyde-releasing products.

10. The preservative composition according to claim 1, wherein the preservative composition is suitable for use in a wallboard joint compound, a pulp and paper slurry, a mineral slurry, an asphalt emulsion, a mastic, or a mixture of thereof.

11. A wallboard joint compound, a pulp and paper slurry, a mineral slurry, an asphalt emulsion, or a mastic, which comprises the preservative composition of claim 1.

12. A method for inhibiting the growth of bacteria in a material during storage, or for inhibiting the growth of fungi in a material during storage, or for inhibiting the growth of bacteria and fungi in a material during storage, wherein the material is selected from the group consisting of a wallboard joint compound, a pulp and paper slurry, a mineral slurry, an asphalt emulsion, and a mastic, wherein the method comprises the steps of:
a) introducing BIT and a metal salt of a carbamodithioic acid into the material, to produce a protected material; and
b) thoroughly mixing the protected material.

13. The method according to claim 12, wherein the metal salt of a carbamodithioic acid is selected from the group consisting of: sodium N-methylcarbamodithioate (“Metam Sodium”); potassium N-methylcarbamodithioate (“Metam Potassium”); zinc N,N-dimethylcarbamodithioate (“Ziram”); sodium N,N-dimethylcarbamodithioate (“Dibam”); potassium N,N-dimethylcarbamodithioate (“Dibam Potassium”); dimethylcarbamothioylsulfanyl N,N-dimethylcarbamodithioate (“Thiram”); zinc N-[2-(sulfidocarbothioylamino)ethyl]carbamodithioate (“Zineb”); disodium N-[2-(sulfidocarbothioylamino)ethyl]carbamodithioate (“Nabam”); zinc, manganese(2+)N-[2-(sulfidocarbothioylamino)ethyl]carbamodithioate (“Mancozeb”); manganese(2+)N-[2-(sulfidocarbothioylamino)ethyl]carbamodithioate (“Maneb”); zinc N-[1-(sulfidocarbothioylamino)propan-2-yl]carbamodithioate (“Propineb”); tetrahydro-3,5-dimethyl-2H-1,3,5-thiadiazin-2-thion (“Dazomet”); and mixtures thereof.

14. The method according to claim 12, wherein the metal salt of a carbamodithioic acid is selected from the group consisting of Dibam, Dibam Potassium, Ziram, Thiram, and mixtures thereof.

15. The method according to claim 12, wherein the metal salt of a carbamodithioic acid is Ziram.

16. The method according to claim 12, wherein the growth of bacteria is inhibited.

17. The method according to claim 12, wherein the growth of bacteria and fungi are inhibited.

18. The method according to claim 12, wherein the growth of Alcaligenes faecalis, Enterobacter aerogenes, Escherichia coli, and Pseudomonas aeruginosa bacteria are inhibited.

19. The method according to claim 12, wherein the growth of Pseudomonas aeruginosa bacteria is synergistically inhibited.

20. The method according to claim 12, wherein the protected material excludes formaldehyde or formaldehyde-releasing products.

21. The method according to claim 12, wherein the selected material is selected from the group consisting of a wallboard joint compound, a mineral slurry, a mastic, and mixtures thereof.

22. The method according to claim 12, wherein the selected material is a wallboard joint compound.

23. A protected material manufactured by the method according to claim 12, wherein the metal salt of a carbamodithioic acid is selected from the group consisting of Dibam, Dibam Potassium, Ziram, Thiram, and mixtures thereof.

24. The protected material manufactured by the method according to claim 23, wherein the metal salt of a carbamodithioic acid is Ziram.
